(19) United States
(12) Patent Application Publication
(10) Pub. No.: US 2005/0241463 A1
(43) Pub. Date: Nov. 3, 2005

(54) Song search system and song search method

(75) Inventor: Shigefumi Urata, Yaita-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 10/992,843

(22) Filed: Nov. 22, 2004

(30) Foreign Application Priority Data
Apr. 15, 2004 (JP) 2004-120862

(51) Int. Cl. A63H 5/00; G10H 7/00; G04B 13/00

(52) U.S. Cl. 84/609

(57) ABSTRACT

The present invention is a song map that is self-organized map that comprises a plurality of neurons that include characteristic vectors made up of data corresponding to a plurality of evaluation items that indicate the characteristics of the song data, and the index-evaluation items are preset from among the evaluation items have a trend from one end to the other end, and song data is mapped for some of the neurons of the song map, and the status of the song map is displayed by points that correspond to respective neurons of song map. In the song map, values that decrease going from one end to the other end are learned as the initial values for the index-evaluation items.

### BACKGROUND OF THE INVENTION

1. Field of the Invention

This invention relates to a song search system and song search method for searching for a desired song from among a large quantity of song data that is recorded in a large-capacity memory means such as a HDD, and more particularly, it relates to a song search system and song search method capable of searching for songs based on impression data that is determined according to human emotion.

2. Description of the Related Art

In recent years, large-capacity memory means such as a HDD have been developed, making it possible for large quantities of song data to be recorded in large-capacity memory means. Searching for large quantities of songs that are recorded in a large-capacity memory means has typically been performed by using bibliographic data such as keywords that include the artist's name, song title, etc., however, when searching using bibliographic data, it is not possible to take into consideration the feeling of the song, and there is a possibility that a song giving a different impression will be found, so this method is not suitable when it is desired to search for songs having the same impression when listened to.

Therefore, in order to be able to search for songs desired by the user based on subjective impression of the songs, an apparatus for searching for desired songs has been proposed in which the subjective conditions required by the user for songs desired to be searched for are input, quantified and output, and from that output, a predicted impression value, which is the quantified impression of the songs to be searched for, is calculated, and using the calculated predicted impression value as a key, a song database in which audio signals for a plurality of songs, and impression values, which are quantified impression values for those songs, are stored, is searched to find desired songs based on the user's subjective image of a song (for example, refer to Japanese patent No. 2002-278547).

However, in the prior art, audio signals for a plurality of songs, and impression values, which are quantified impression values for those songs, were stored in a song database, however, the impression values were biaxial, and when considering the display for the case in which the impression axes were increased, it becomes difficult to easily know what kind of audio signals and what kind of song data having impression values are stored, or in other words, it is difficult easily know the trends of the song data stored in the song database, and thus there was a problem in that it was difficult to predict the search results for the search conditions and for the user to obtain the desired search results.

### SUMMARY OF THE INVENTION

Taking into consideration the problems described above, the object of this invention is to provide a song search system and song search method that make it possible to easily know the trends of song data stored in a song database by simply looking at a displayed song map on which song data are mapped.

This invention is constructed as described below in order to solve the aforementioned problems.

The song search system of the present invention is a song search system that searches for desired song data from among a plurality of song data stored in a song database, the song search system comprising: a song-map-memory means that stores song map which a self-organized map that comprises a plurality of neurons that include characteristic vectors made up of data corresponding to a plurality of evaluation items that indicate the characteristics of said song data; and where the neurons have a trend from one end to the other end for index-evaluations items that are preset from among said evaluation items; a song-mapping means that maps said song data onto some of the neurons of said song map based on a plurality of items of data that display the characteristics of said song data; and a displaying means that displays status of said song map using points that correspond to respective neurons in said song map.

Moreover, in the song search system of the present invention, the song map performs learning using values decreasing from one end to the other end as initial values for said index-evaluation items.

Furthermore, in the song search system of the present invention, the song map is a 2-dimensional map; and two evaluation items from among said evaluation items are set as said index-evaluation items.

Also, the song search method of the present invention is a song search method that searches for desired song data from among a plurality of song data stored in a song database, the song search method comprising: storing song map which is a self-organized map that comprises a plurality of neurons that include characteristic vectors made up of data corresponding to a plurality of evaluation items that indicate the characteristics of said song data; and where the neurons have a trend from one end to the other end for index-evaluations items that are preset from among said evaluation items; mapping said song data onto some of the neurons of said song map based on a plurality of items of data that display the characteristics of said song data; and displaying status of said song map using points that correspond to respective neurons in said song map.

Moreover, in the song search method of the present invention the song map performs learning using values decreasing from one end to the other end as initial values for said index-evaluation items.

Furthermore, in the song search method of the present invention, the song map is a 2-dimensional map; and two evaluation items from among said evaluation items are set as said index-evaluation items.

### BRIEF DESCRIPTION OF THE DRAWINGS

FIG. 1 is a block diagram showing the construction of an embodiment of the song search system of the present invention.

FIG. 2 is a block diagram showing the construction of a neural-network-learning apparatus that learns in advance a neural network used by the song search apparatus shown in FIG. 1.

FIG. 3 is a flowchart for explaining the song-registration operation by the song search apparatus shown in FIG. 1.

FIG. 4 is a flowchart for explaining the characteristic-data-extraction operation by the characteristic-data-extraction unit shown in FIG. 1.

FIG. 5 is a flowchart for explaining the learning operation for learning a hierarchical-type neural network by the neural-network-learning apparatus shown in FIG. 2.

FIG. 6 is a flowchart for explaining the learning operation for learning a song map by the neural-network-learning apparatus shown in FIG. 2.

FIG. 7 is a flowchart for explaining the song search operation of the song search apparatus shown in FIG. 1.

FIG. 8 is a drawing for explaining the learning algorithm for learning a hierarchical-type neural network by the neural-network-learning apparatus shown in FIG. 2.

FIG. 9 is a drawing for explaining the learning algorithm for learning a song map by the neural-network-learning apparatus shown in FIG. 2.

FIG. 10 is a drawing for explaining the initial song-map settings that are learned by the neural-network-learning apparatus shown in FIG. 2.

FIG. 11 is a drawing showing an example of the display screen of the PC-display unit shown in FIG. 1.

FIG. 12 is a drawing showing an example of the display of the mapping-state-display area shown in FIG. 11.

FIG. 13 is a drawing showing an example of the display of the song-map-display area shown in FIG. 12.

FIG. 14 is a drawing showing an example of the display of the search-conditions-input area shown in FIG. 11.

FIG. 15 is a drawing showing an example of the display of the search-results-display area shown in FIG. 11.

FIG. 16 is a drawing showing an example of the display of the search-results-display area shown in FIG. 11.

FIG. 17 is a drawing showing an example of the entire-song-list-display area that is displayed in the example of the display screen shown in FIG. 11.

FIG. 18A and FIG. 18B are drawings showing an example of the keyword-search-area displayed on the display screen shown in FIG. 11.

FIG. 19 is a flowchart for explaining the re-learning operation of hierarchical-type neural network of an embodiment of the song search system of the present invention.

FIG. 20 is a drawing showing an example of the display of the correction-instruction area that is displayed in the example of the display screen shown in FIG. 11.

FIG. 21 is a flowchart for explaining the re-learning operation of hierarchical-type neural network that is used by the impression-data-conversion unit shown in FIG. 1.

FIG. 22 is a drawing showing an example of the display of the re-learning-instruction area that is displayed in the example of the display screen shown in FIG. 11.

FIG. 23 is a flowchart for explaining the re-registration operation of song-data of the song-search apparatus shown in FIG. 1.

### DETAILED DESCRIPTION OF THE PREFERRED EMBODIMENTS

The preferred embodiment of the present invention will be explained below based on the drawings.

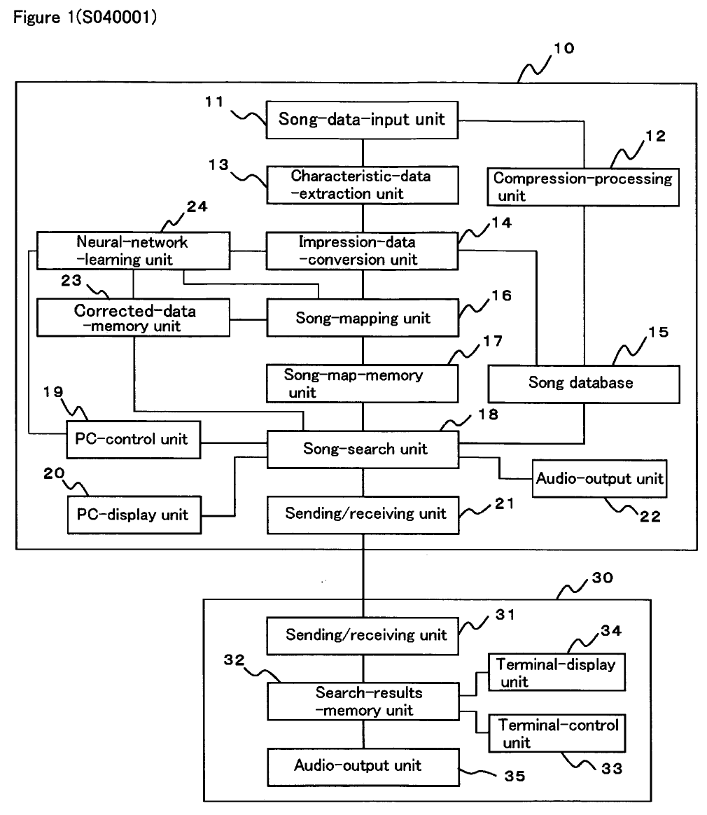

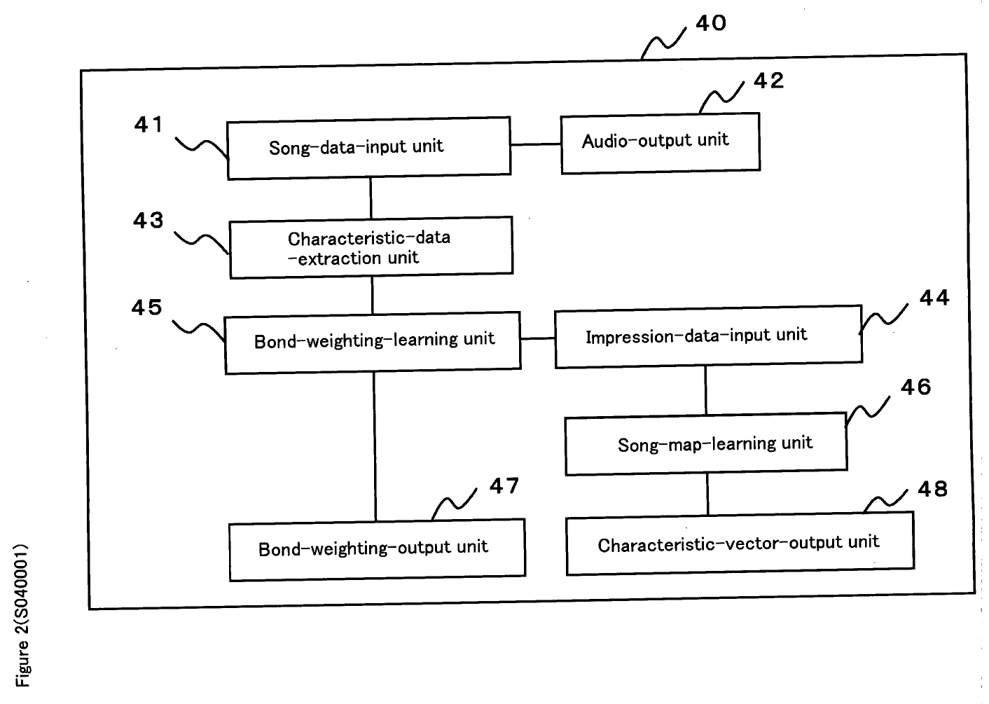

FIG. 1 is a block diagram showing the construction of an embodiment of the song search system of this invention, and FIG. 2 is a block diagram showing the construction of a neural-network-learning apparatus that learns in advance the neural network used by the song-search apparatus shown in FIG. 1.

As shown in FIG. 1, the embodiment of the present invention comprises a song search apparatus 10 and terminal apparatus 30 that are connected by a data-transmission path such as USB or the like, and where the terminal apparatus 30 can be separated from the song search apparatus and become mobile.

As shown in FIG. 1, the song search apparatus 10 comprises: a song-data-input unit 11, a compression-processing unit 12, a characteristic-data-extraction unit 13, an impression-data-conversion unit 14, a song database 15, a song-mapping unit 16, a song-map-memory unit 17, a song-search unit 18, a PC-control unit 19, a PC-display unit 20, a sending/receiving unit 21, a audio-output unit 22, a corrected-data-memory unit 23 and a neural-network-learning unit 24.

The song-data-input unit 11 has a function of reading a memory medium such as a CD, DVD or the like on which song data is recorded, and is used to input song data from a memory medium such as a CD, DVD or the like and output it to the compression-processing unit 12 and characteristic-data-extraction unit 13. Instead of a memory medium such as a CD, DVD or the like, it is also possible to input song data (distribution data) by way of a network such as the Internet. When compressed song data is input, it expands the compressed song data and output it to the characteristic-data-extraction unit 13.

When registering songs, the compression-processing unit 12 compresses the song data that is input from the song-data-input unit 11 by a compressing format such as MP3 or ATRAC (Adaptive Transform Acoustic Coding) or the like, and stores the compressed song data in the song database 15 together with bibliographic data such as the artist name, song title, etc.

The characteristic-data-extraction unit 13 extracts characteristic data containing changing information from the song data input from the song-input unit 11, and outputs the extracted characteristic data to the impression-data-conversion unit 14.

The impression-data-conversion unit 14 uses a pre-learned hierarchical-type neural network to convert the characteristic data input from the characteristic-data-extraction unit 13 to impression data that is determined according to human emotion, and together with outputting the converted impression data to the song-mapping unit 16, correlates the characteristic data that was input from the characteristic-data-extraction unit 13 and the converted impression data with the song data and registers them in the song database 15.

The song database 15 is a large-capacity memory means such as a HDD or the like, and it correlates and stores the song data and bibliographic data that are compressed by the compression-processing unit 12, characteristic data extracted by the characteristic-data-extraction unit 13 and impression data converted by the impression-data-conversion unit 14.

Based on the impression data that is input from the impression-data-conversion unit 14, the song-mapping unit 16 maps song data onto a self-organized song map for which pre-learning is performed in advance, and stores the song map on which song data has been mapped in a song-map-memory unit 17.

The song-map-memory unit 17 is a large-capacity memory means such as a HDD or the like, and stores a song map on which song data is mapped by the song-mapping unit 16.

The song-search unit 18 searches the song database 15 based on the impression data and bibliographic data that are input from the PC-control unit 19 and displays the search results on the PC-display unit 20, as well as searches the song-map-memory unit 17 based on a representative song that is selected using the PC-control unit 19, and displays the search results of representative song on the PC-display unit 20. Also, the song-search unit 18 outputs song data selected using the PC-control unit 19 to the terminal apparatus 30 by way of the sending/receiving unit 21.

Also, the song-search unit 18 reads song data and impression data from the song database 15, and together with outputting the read song data to audio-output unit 22 in order to output the song by audio, it corrects the impression data based on instructions from the user that listened to the audio output, and then together with updating the impression data that is stored in the song database 15, it reads the characteristic data from the song database 15 and stores the corrected data and characteristic data in the corrected-data-memory unit 23 as re-learned data.

The PC-control unit 19 is an input means such as a keyboard, mouse or the like, and is used to perform input of search conditions for searching song data stored in the song database 15 and song-map-memory unit 17, and is used to perform input for selecting song data to output to the terminal apparatus 30, input for correcting the impression data, input for giving instructions to automatically correct the impression data, input for giving instructions to re-learn the hierarchical-type neural network, and input for giving instructions for re-registering the song data.

The PC-display unit 20 is a display means such as a liquid-crystal display or the like, and it is used to display the mapping status of the song map stored in the song-map-memory unit 17, display search conditions for searching song data stored in the song database 15 and song-map-memory unit 17, and display found song data (search results).

The sending/receiving unit 21 is constructed such that it can be connected to the sending/receiving unit 31 of the terminal apparatus 30 by a data-transmission path such as a USB or the like, and together with outputting the song data, which is searched by the song-search unit 18 and selected using the PC-control unit 19, to the sending/receiving unit 31 of the terminal apparatus 30, it receives correction instructions from the terminal apparatus 30.

The audio-output unit 22 expands the song data that is stored in the song database 15, and is an audio player that reproduces that song data.

The corrected-data-memory unit 23 is a memory means such as a HDD or the like, that stores the corrected impression data and characteristic data as re-learned data.

The neural-network-learning unit 24 is a means for re-learning hierarchical-type neural network that is used by the impression-data-conversion unit 14, and it reads the bond-weighting values for each neuron from impression-data-conversion unit 14, and sets the bond-weighting values for each read neuron as initial values, then re-learns the hierarchical-type neural network according to the re-learned data that is stored in the corrected-data-memory unit 23, or in other words, re-learns the bond-weighting values for each neuron, and updates the bond-weighting values w for each neuron of the impression-data-conversion unit 14 to the re-learned bond-weighting values for each neuron.

The terminal apparatus 30 is an audio-reproduction apparatus such as a portable audio player that has a large-capacity memory means such as a HDD or the like, or MD player or the like, and as shown in FIG. 1, it comprises: a sending/receiving unit 31, search-results-memory unit 32, terminal-control unit 33, terminal-display unit 34 and audio-output unit 35.

The sending/receiving unit 31 is constructed such that it can be connected to the sending/receiving unit 21 of the song-search apparatus 10 by a data-transmission path such as USB or the like, and together with storing song data input from the sending/receiving unit 21 of the song-search apparatus 10 in the search-results-memory unit 32, it sends correction instructions stored in the search-results-memory unit 32 to the song-search apparatus 10, when terminal apparatus 30 is connected to song-search apparatus 10.

The terminal-control unit 33 is used to input instructions to select or reproduce song data stored in the search-results-memory unit 32, and performs input related to reproducing the song data such as input of volume controls or the like, and input for giving instructions to correct the impression data corresponding to the song being reproduced.

The terminal-display unit 34 is a display means such as a liquid-crystal display or the like, that displays the song title of a song being reproduced or various controls guidance.

The audio-output unit 35 is an audio player that expands and reproduces song data that is compressed and stored in the search-results-memory unit 32.

The neural-network-learning apparatus 40 is an apparatus that learns a hierarchical-type neural network that is used by the impression-data-conversion unit 14, and a song map that is used by the song-mapping unit 16, and as shown in FIG. 2, it comprises: a song-data-input unit 41, an audio-output unit 42, a characteristic-data-extraction unit 43, an impression-data-input unit 44, a bond-weighting-learning unit 45, a song-map-learning unit 46, a bond-weighting-output unit 47, and a characteristic-vector-output unit 48.

The song-data-input unit 41 has a function for reading a memory medium such as a CD or DVD or the like on which song data is stored, and inputs song data from the memory medium such as a CD, DVD or the like and outputs it to the audio-output unit 42 and characteristic-data-extraction unit 43. Instead of a memory medium such as a CD, DVD or the like, it is also possible to input song data (distribution data) by way of a network such as a Internet. When compressed song data is input, it expands the compressed song data, and output it to the audio-output unit 42 and characteristic-data-extraction unit 43.

The audio-output unit 42 is an audio player that expands and reproduces the song data input from the song-data-input unit 41.

The characteristic-data-extraction unit 43 extracts characteristic data containing changing information from the song data input from the song-data-input unit 41, and outputs the extracted characteristic data to the bond-weighting-learning unit 45.

Based on the audio output from the audio-output unit 42, the impression-data-input unit 44 receives the impression data input from an evaluator, and outputs the received impression data to the bond-weighting-learning unit 45 as a teacher signal to be used in learning the hierarchical-type neural network, as well as outputs it to the song-map-learning unit 46 as input vectors for the self-organized map.

Based on the characteristic data input from the characteristic-data-extraction unit 43 and the impression data input from the impression-data-input unit 44, the bond-weighting-learning unit 45 learns the hierarchical-type neural network and updates the bond-weighting values for each of the neurons, then outputs the updated bond-weighting values by way of the bond-weighting-output unit 47. The learned hierarchical-type neural network (updated bond-weighting values) is transferred to the impression-data-conversion unit 14 of the song-search apparatus 10.

The song-map-learning unit 46 learns the self-organized map using impression data input from the impression-data-input unit 44 as input vectors for the self-organized map, and updates the characteristic vectors for each neuron, then outputs the updated characteristic vectors by way of the characteristic-vector-output unit 48. The learned self-organized map (updated characteristic vectors) is stored in the song-map-memory unit 17 of the song-search apparatus 10 as a song map.

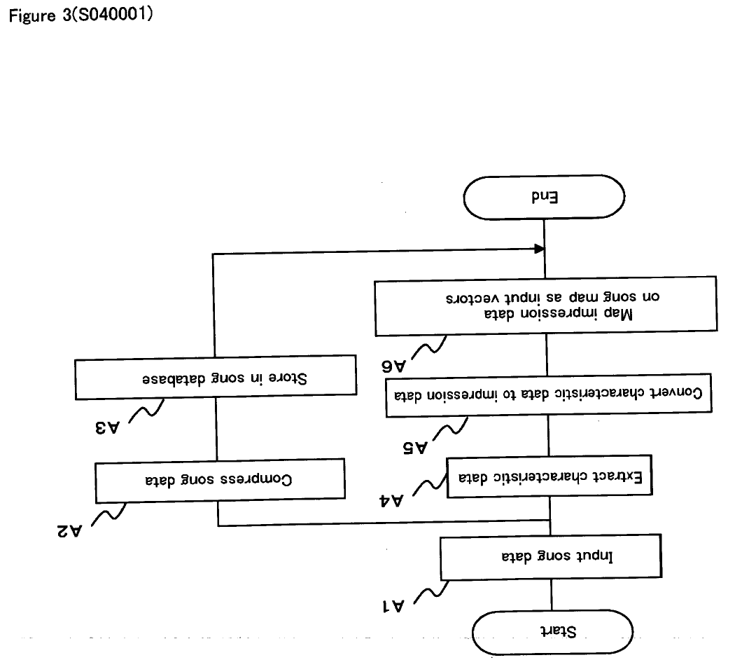

Next, FIG. 3 to FIG. 23 will be used to explain in detail the operation of the embodiment of the present invention.

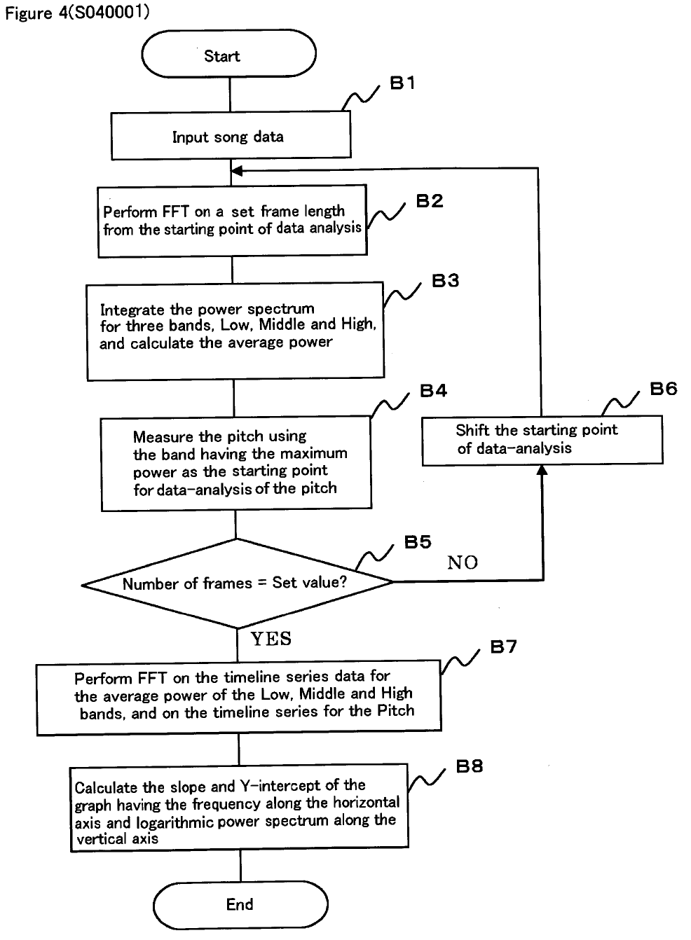

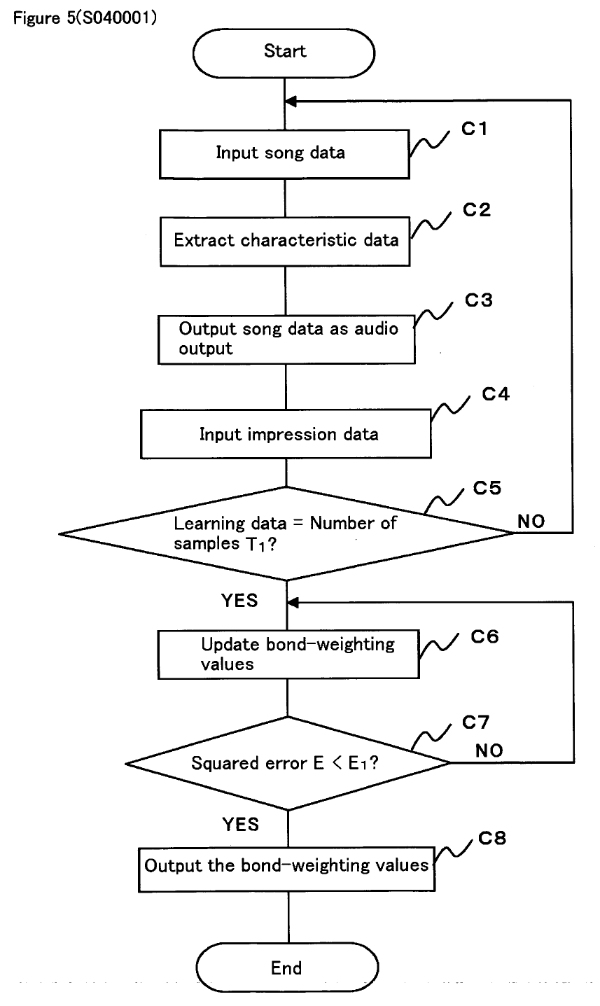

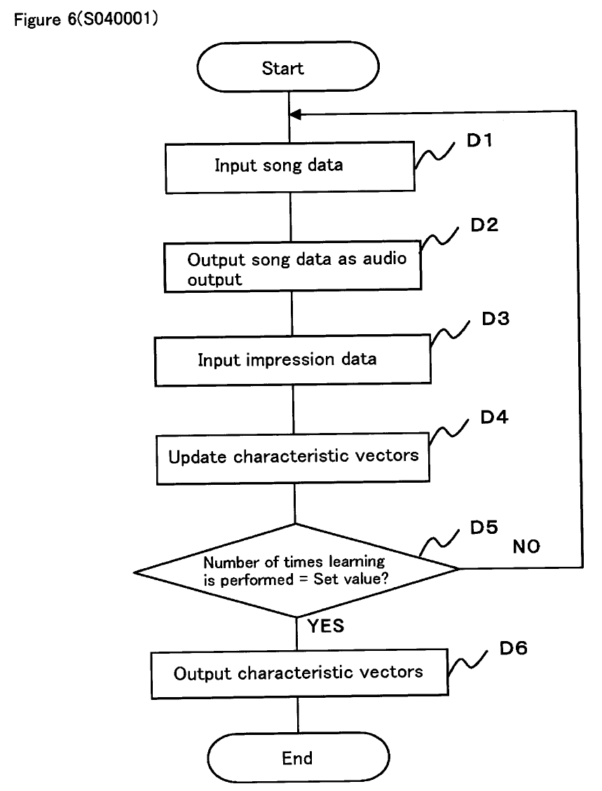

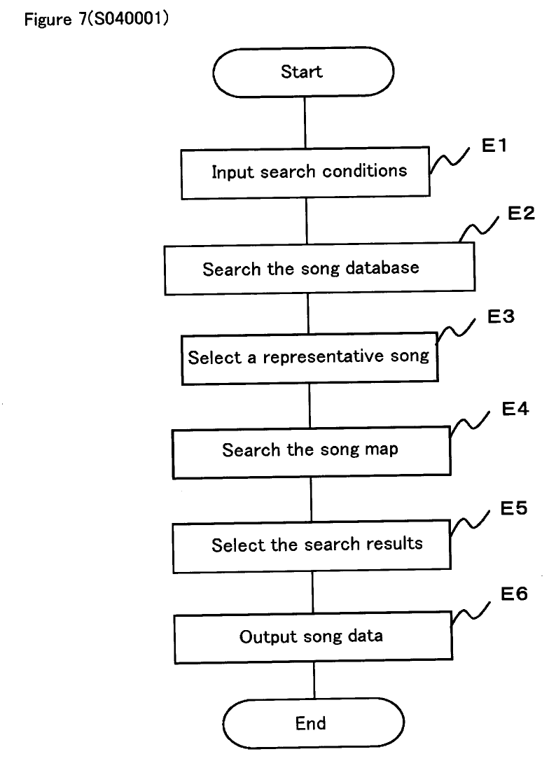

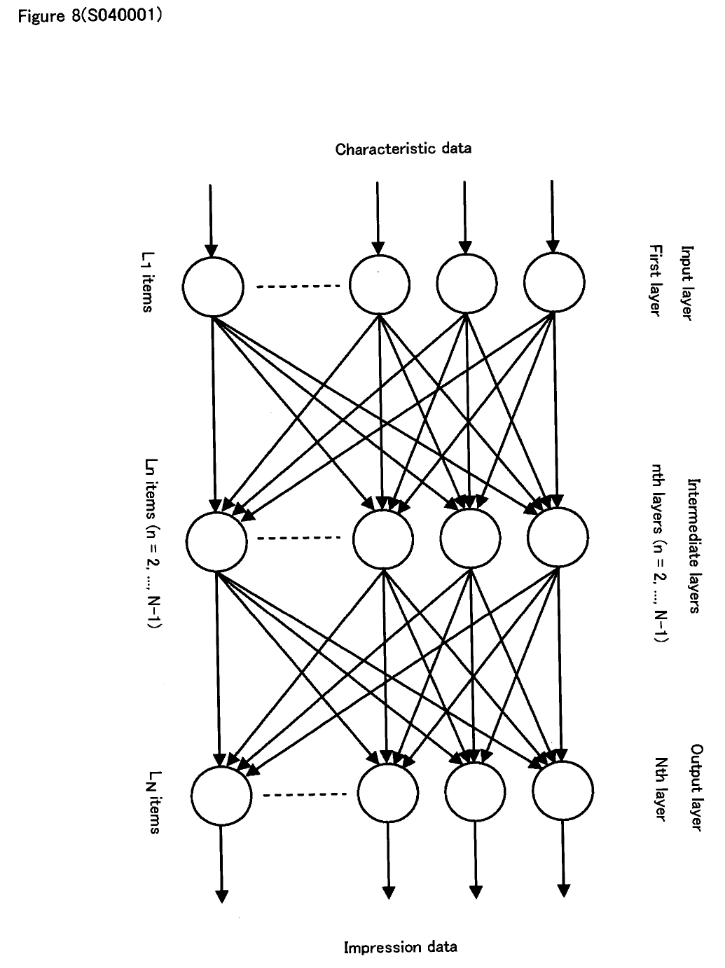

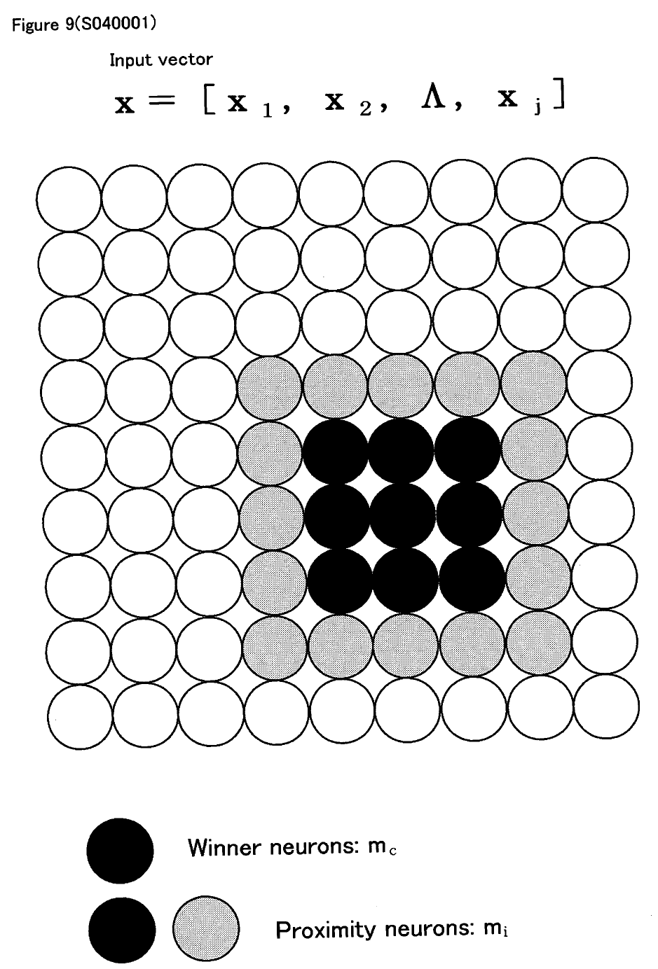

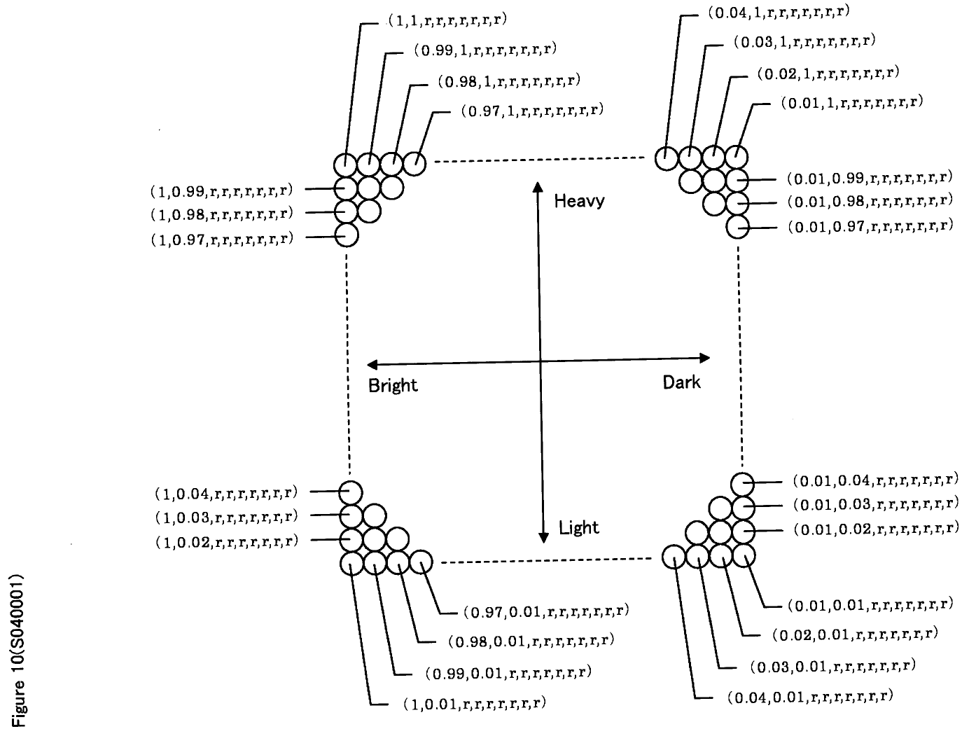

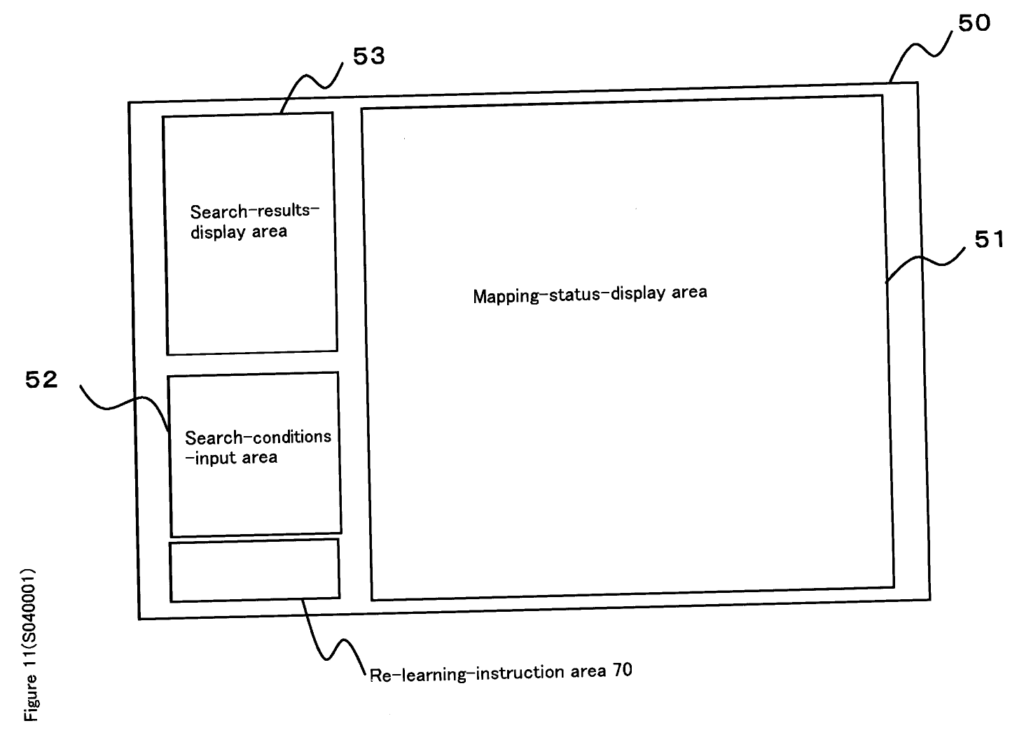

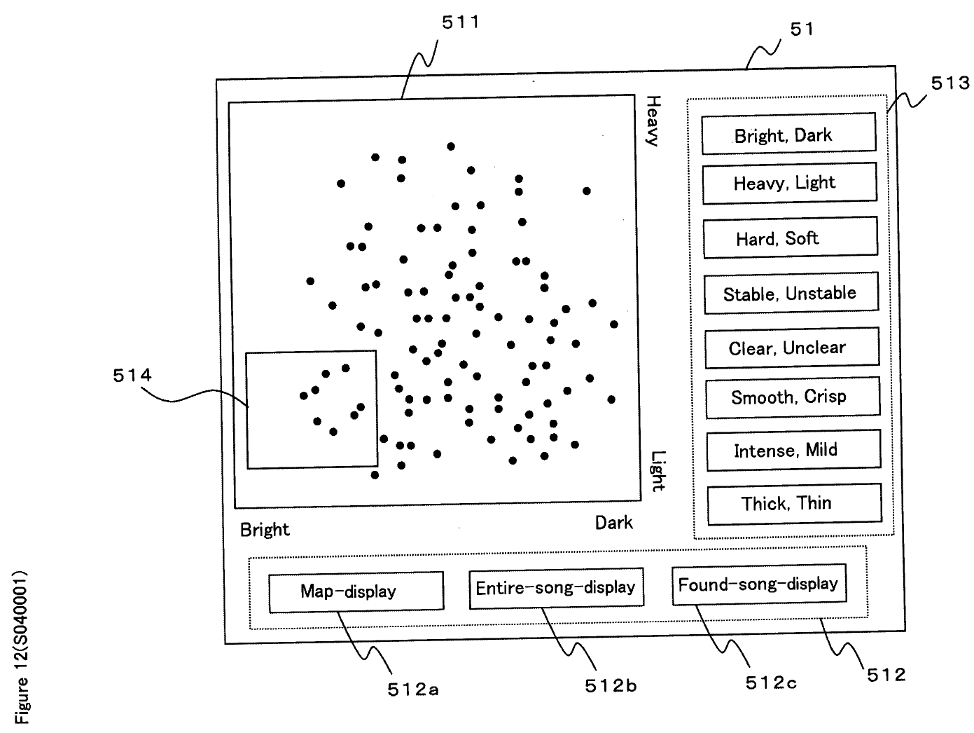

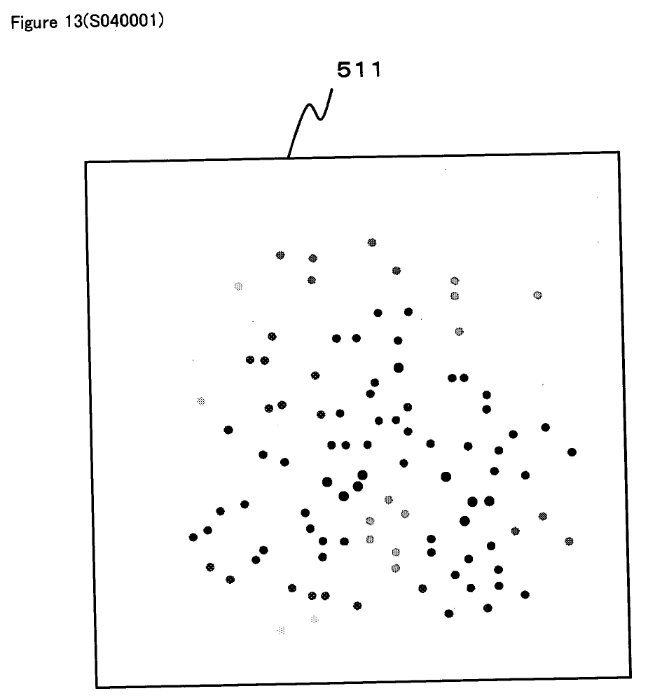

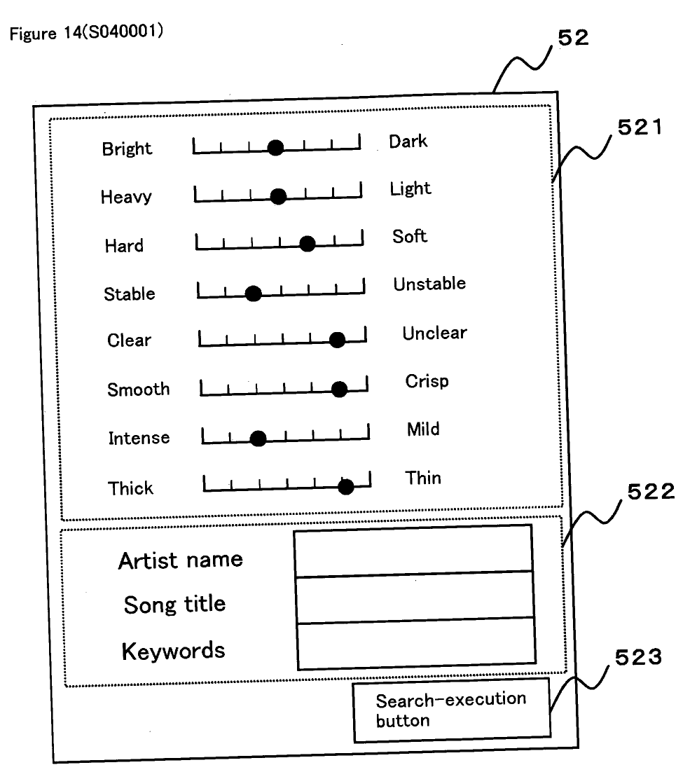

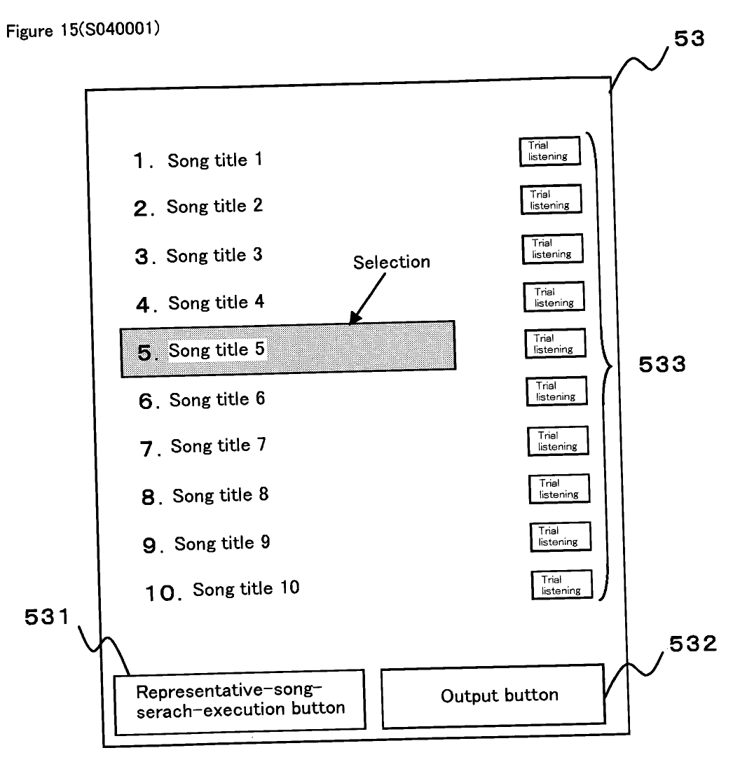

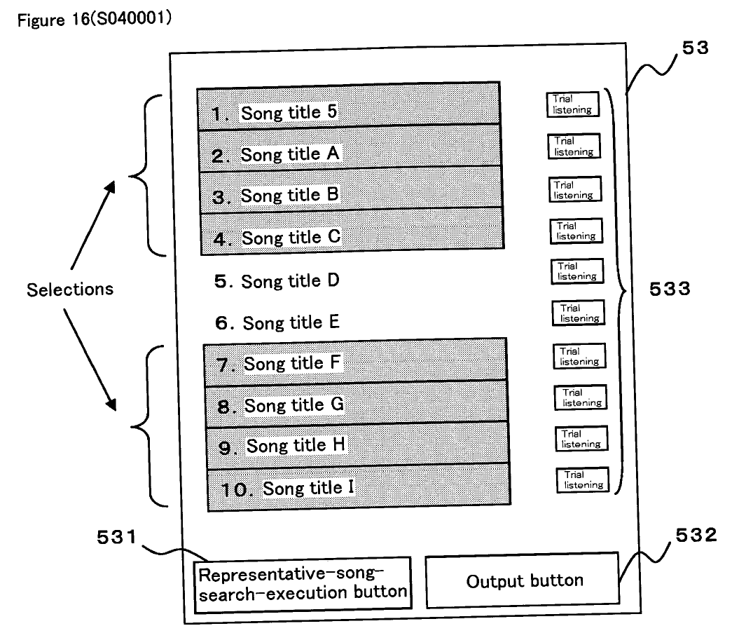

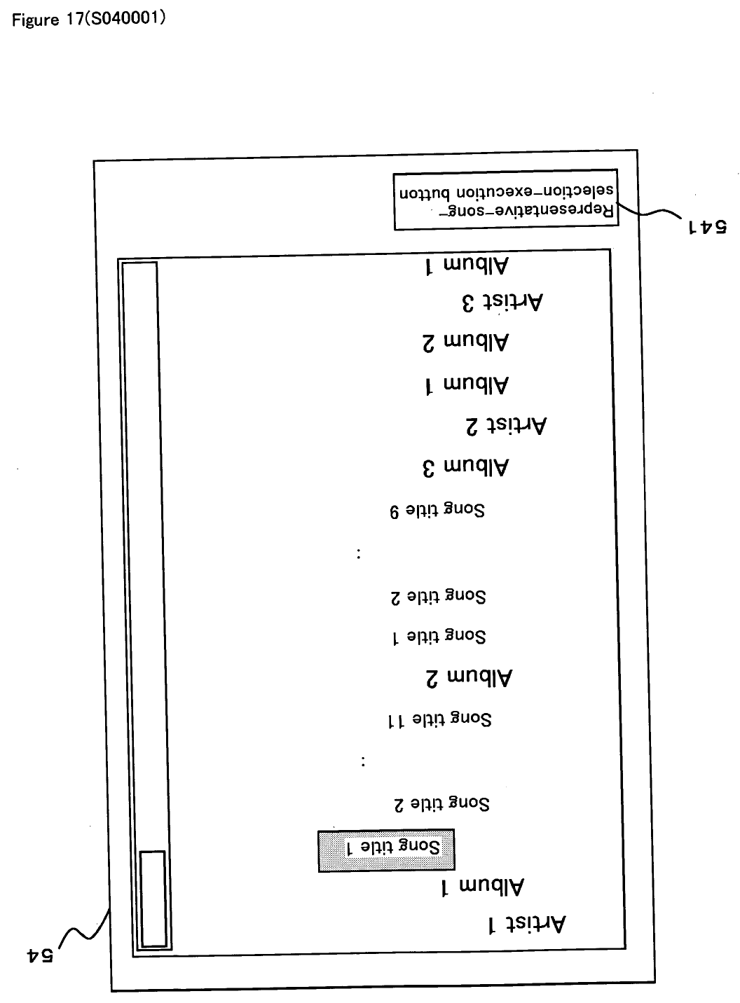

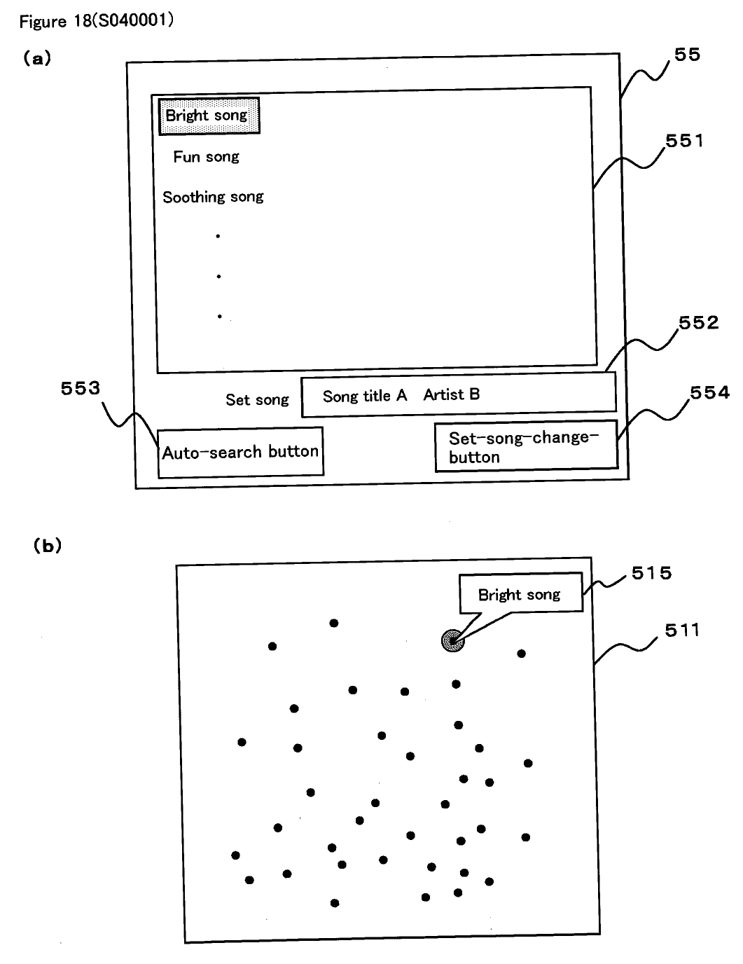

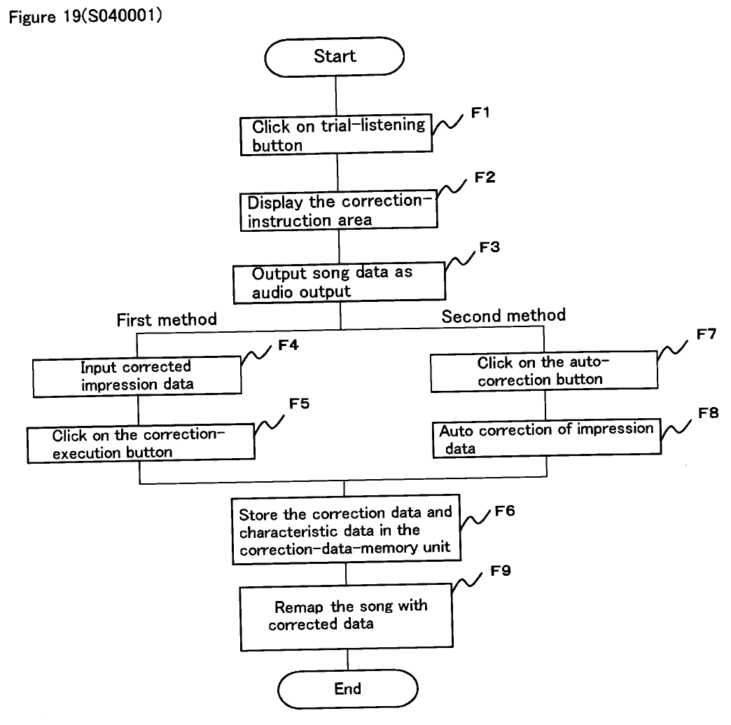

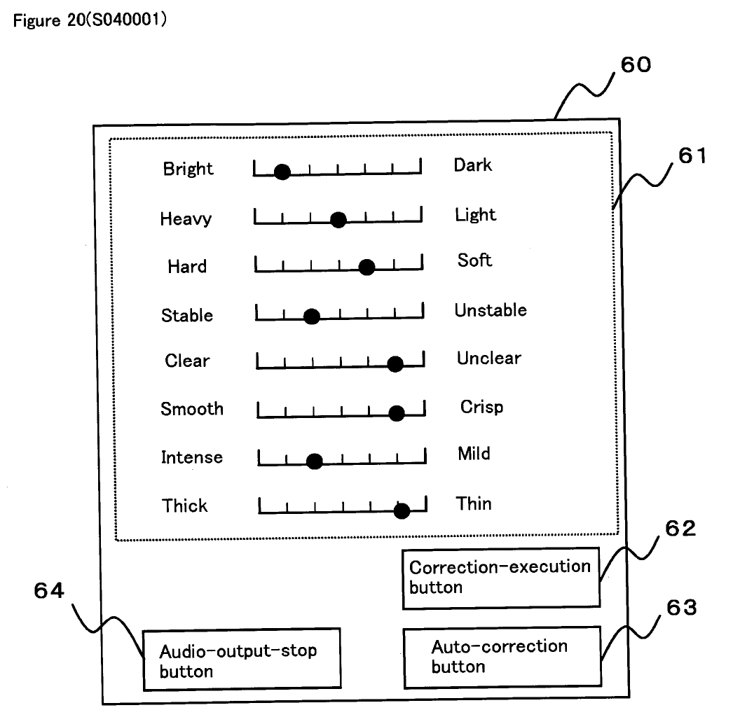

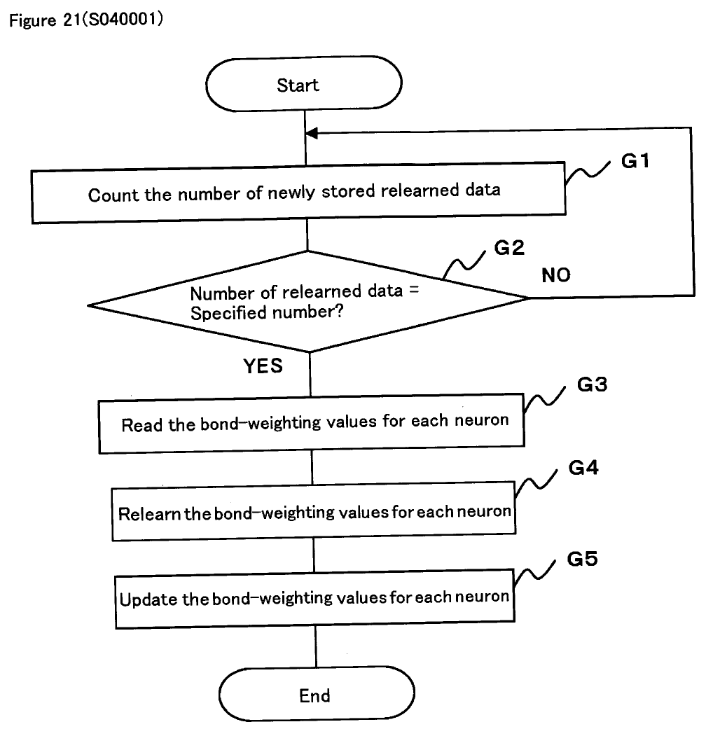

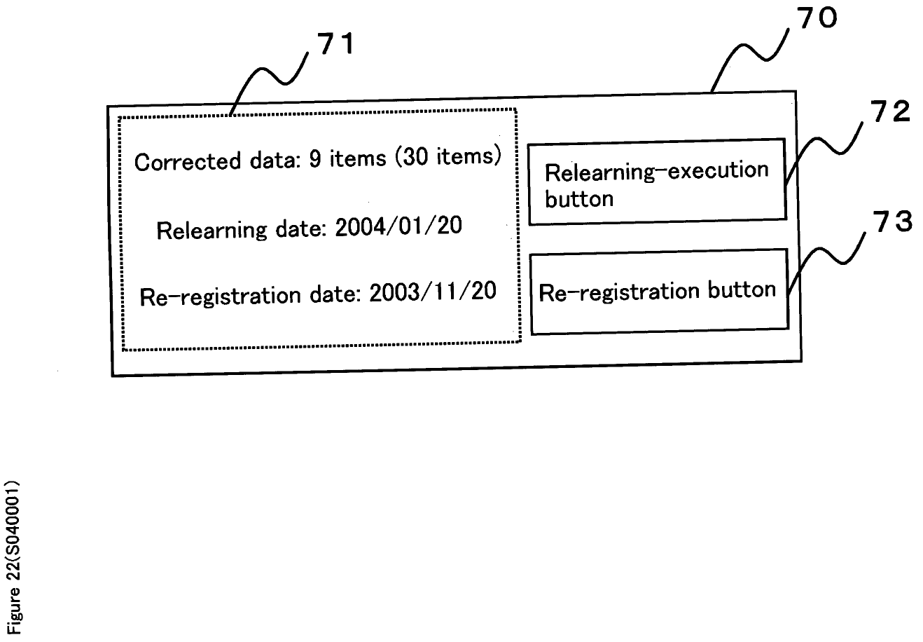

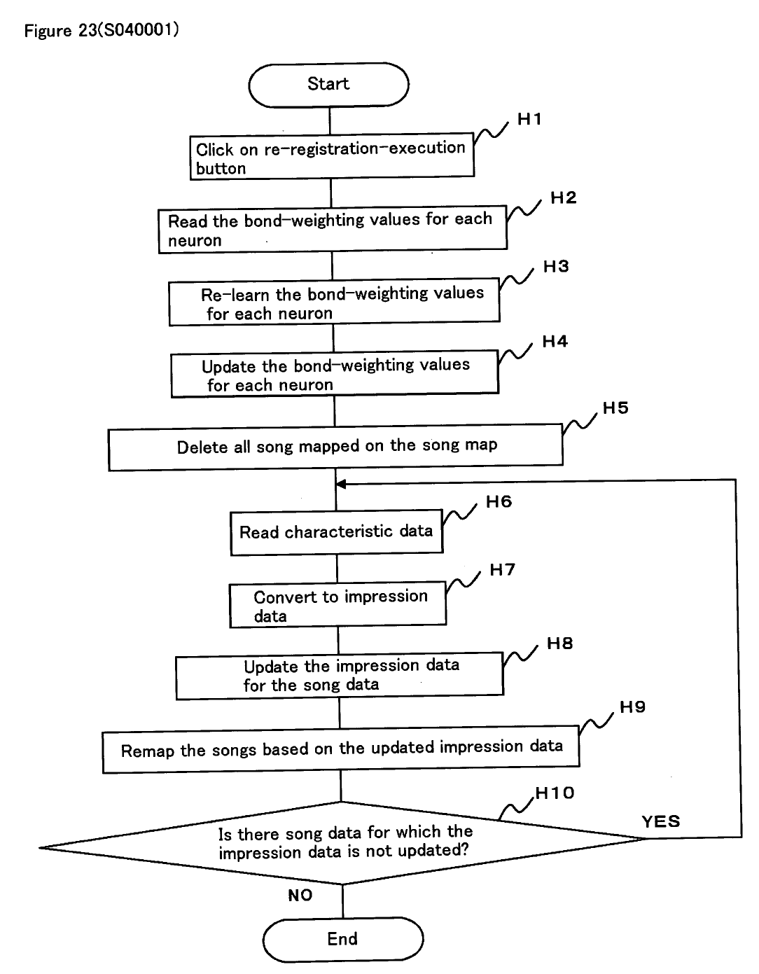

FIG. 3 is a flowchart for explaining the song-registration operation by the song search apparatus shown in FIG. 1; FIG. 4 is a flowchart for explaining the characteristic-data-extraction operation by the characteristic-data-extraction unit shown in FIG. 1; FIG. 5 is a flowchart for explaining the learning operation for learning a hierarchical-type neural network by the neural-network-learning apparatus shown in FIG. 2; FIG. 6 is a flowchart for explaining the learning operation for learning a song map by the neural-network-learning apparatus shown in FIG. 2; FIG. 7 is a flowchart for explaining the song search operation of the song-search apparatus shown in FIG. 1; FIG. 8 is a drawing for explaining the learning algorithm for learning a hierarchical-type neural network by the neural-network-learning apparatus shown in FIG. 2; FIG. 9 is a drawing for explaining the learning algorithm for learning a song map by the neural-network-learning apparatus shown in FIG. 2; FIG. 10 is a drawing for explaining the initial song-map settings that are learned by the neural-network-learning apparatus shown in FIG. 2; FIG. 11 is a drawing showing an example of the display screen of the PC-display unit shown in FIG. 1; FIG. 12 is a drawing showing an example of the display of the mapping-state-display area shown in FIG. 11; FIG. 13 is a drawing showing an example of the display of the song-map-display area shown in FIG. 12; FIG. 14 is a drawing showing an example of the display of the search-conditions-input area shown in FIG. 11; FIG. 15 is a drawing showing an example of the display of the search-results-display area shown in FIG. 11; FIG. 16 is a drawing showing an example of the display of the search-results-display area shown in FIG. 11; FIG. 17 is a drawing showing an example of the entire-song-list-display area that is displayed in the example of the display screen shown in FIG. 11; FIG. 18A and FIG. 18B are drawings showing an example of the keyword-search-area displayed on the display screen shown in FIG. 11; FIG. 19 is a flowchart for explaining the re-learning operation of hierarchical-type neural network of an embodiment of the song search system of the present invention; FIG. 20 is a drawing showing an example of the display of the correction-instruction area that is displayed in the example of the display screen shown in FIG. 11; FIG. 21 is a flowchart for explaining the re-learning operation of hierarchical-type neural network that is used by the impression-data-conversion unit shown in FIG. 1; FIG. 22 is a drawing showing an example of the display of the re-learning-instruction area that is displayed in the example of the display screen shown in FIG. 11; FIG. 23 is a flowchart for explaining the re-registration operation of song-data of the song-search apparatus shown in FIG. 1.

First, FIG. 3 will be used to explain in detail the song-registration operation by the song-search apparatus 10.

A memory medium such as a CD, DVD or the like on which song data is recorded is set in the song-data-input unit 11, and the song data is input from the song-data-input unit 11 (step A1).

The compression-processing unit 12 compresses song data that is input from the song-data-input unit 11 (step A2), and stores the compressed song data in the song database 15 together with bibliographic data such as the artist name, song title or the like (step A3).

The characteristic-data-extraction unit 13 extracts characteristic data that contains changing information from song data input from the song-data-input unit 11 (step A4).

As shown in FIG. 4, the extraction operation for extracting characteristic data by the characteristic-data-extraction unit 13 receives input of song data (step B1), and performs FFT (Fast Fourier Transform) on a set frame length from a preset starting point for data analysis of the song data (step B2), then calculates the power spectrum. Before performing step B2, it is also possible to perform down-sampling in order to improve speed.

Next, the characteristic-data-extraction unit 13 presets Low, Middle and High frequency bands, and integrates the power spectrum for the three bands, Low, Middle and High, to calculate the average power (step B3), and of the Low, Middle and High frequency bands, uses the bands having the maximum power as the starting point for data analysis of the pitch, and measures the Pitch (step B4).

The processing operation of step B2 to step B4 is performed for a preset number of frames, and the characteristic-data-extraction unit 13 determines whether or not the number of frames for which the processing operation of step B2 to step B4 has been performed has reached a preset setting (step B5), and when the number of frames for which the processing operation of step B2 to step B4 has been performed has not yet reached the preset setting, it shifts the starting point for data analysis (step B6), and repeats the processing operation of step B2 to step B4.

When the number of frames for which the processing operation of step B2 to step B4 has been performed has reached the preset setting, the characteristic-data-extraction unit 13 performs FFT on the timeline serious data of the average power of the Low, Middle and High bands calculated by the processing operation of step B2 to step B4, and performs FFT on the timeline serious data of the Pitch measured by the processing operation of step B2 to step B4 (step B7).

Next, from the FFT analysis results for the Low, Middle and High frequency bands, and the Pitch, the characteristic-data-extraction unit 13 calculates the slopes of the regression lines in a graph with the logarithmic frequency along the horizontal axis and the logarithmic power spectrum along the vertical axis, and the y-intercept of that regression line as the changing information (step B8), and outputs the slopes and y-intercept of the regression lines for each of the respective Low, Middle and High frequency bands as eight items of characteristic data to the impression-data-conversion unit 14.

The impression-data-conversion unit 14 uses a hierarchical-type neural network having an input layer (first layer), intermediate layers (nth layers) and an output layer (Nth layer) as shown in FIG. 8, and by inputting the characteristic data extracted by the characteristic-data-extraction unit 13 into the input layer (first layer), it outputs the impression data from the output layer (Nth layer), or in other words, converts the characteristic data to impression data (step A5), and together with outputting the impression data output from the output layer (Nth layer) to the song-mapping unit 16, it stores the characteristic data input from the characteristic-data-extraction unit 13 and the impression data output from the output layer (Nth layer) in the song database 15 together with the song data. The bond-weighting values w of each of the neurons in the intermediate layers (nth layers) is pre-learned by evaluators. Also, in the case of this embodiment, there are eight items, as described above, of characteristic data that are input into the input layer (first layer), or in other words, characteristic data that are extracted by the characteristic-data-extraction unit 13, and they are determined according to human emotion as following eight items of impression data: (bright, dark), (heavy, light), (hard, soft), (stable, unstable), (clear, unclear), (smooth, crisp), (intense, mild) and (thick, thin), each item is set so that it is expressed by 7-level evaluation. Therefore, there are eight neurons L₁ in the input layer (first layer) and eight neurons L_{N} in the output layer (Nth layer), and the number of neurons Ln in the intermediate layers (nth layers: n=2, . . . , N−1) is set appropriately.

The song-mapping unit 16 maps the songs input from the song-data-input unit 11 on locations of the song map stored in the song-map-memory unit 17. The song map used in the mapping operation by the song-mapping unit 16 is a self-organized map (SOM) in which the neurons are arranged systematically in two dimensional (in the example shown in FIG. 9, it is a 9×9 square), and is a learned neural network that does not require a teacher signal, and is a neural network in which the capability to classify an input pattern groups according to the degree of similarity is acquired autonomously. In this embodiment, a 2-dimensional SOM is used in which the neurons are arranged in a 100×100 square shape, however, the neuron arrangement can square shaped or can also be honeycomb shaped.

Also, the song map that is used in the mapping operation by the song-mapping unit 16 is learned in advance, and the pre-learned nth dimensional characteristic vectors mᵢ(t) εRⁿ are included in the each neurons, and the song-mapping unit 16 uses the impression data converted by the impression-data-conversion unit 14 as input vectors xⱼ, and maps the input songs onto the neurons closest to the input vectors xⱼ, or in other words, neurons that minimize the Euclidean distance ∥xⱼ−mᵢ∥ (step A6), and then stores the mapped song map in the song-map memory unit 17.

Next, FIG. 5 and FIG. 8 will be used to explain in detail the learning operation of the hierarchical-type neural network that is used in the conversion operation (step A5) by the impression-data-conversion unit 14.

Learning the hierarchical-type neural network (bond-weighting values w) by evaluator is performed, for example, by using the neural-network-learning apparatus 40 shown in FIG. 2, and first pre-learned data (characteristic data +impression data of the song data) is input in order to learn the hierarchical-type neural network (bond-weighting values w) in advance.

A memory medium such as a CD, DVD or the like on which song data is stored is set in the song-data-input unit 41, and input song data from the song-data-input unit 41 (step C1), and the characteristic-data-extraction unit 43 extracts characteristic data containing changing information from the song data input from the song-data-input unit 41 (step C2).

Also, the audio-output unit 42 outputs the song data input from the song-data-input unit 41 as audio output (step C3), and then by listening to the audio output from the audio-output unit 42, the evaluator evaluates the impression of the song according to emotion, and inputs the evaluation results from the impression-data-input unit 44 as impression data (step C4), then the bond-weighting-learning unit 45 receives the impression data input from the impression-data-input unit 44 as a teaching signal. In this embodiment, the eight items (bright, dark), (heavy, light), (hard, soft), (stable, unstable), (clear, unclear), (smooth, crisp), (intense, mild), (thick, thin) are determined according to human emotion as evaluation items for the impression, and seven levels of evaluation for each evaluation item are received by the song-data-input unit 41 as impression data.

Next, the learning data comprising characteristic data and the input impression data are checked whether or not they reach a preset number of samples T₁ (step C5), and the operation of steps C1 to C4 is repeated until the learning data reaches the number of samples T₁.

Learning of the hierarchical-type neural network by the bond-weighting-learning unit 45, or in other words, updating the bond-weighting values w for each neurons, is performed using an error back-propagation learning method.

First, as initial values, the bond-weighting values w for all of the neurons in the intermediate layers (nth layers) are set randomly to small values in the range −0.1 to 0.1, and the bond-weighting-learning unit 45 inputs the characteristic data extracted by the characteristic-data-extraction unit 43 into the input layer (first layer) as the input signals xⱼ (j=1, 2, . . . , 8), then the output for each neuron is calculated going from the input layer (first layer) toward the output layer (Nth layer).

Next, the bond-weighting-learning unit 45 uses the impression data input from the impression-data-input unit 44 as teaching signals yⱼ (j=1, 2, . . . , 8) to calculate the learning rule δⱼ^{N} from the error between the output outⱼ^{N} from the output layer (Nth layer) and the teaching signals yⱼ using the following equation 1.
δⱼ^{N}=−(yⱼ−outⱼ^{N})outⱼ^{N}(1−outⱼ^{N}) [Equation 1]

Next, the bond-weighting-learning unit 45 uses the learning rule δⱼ^{N}, and calculates the error signals δⱼⁿ from the intermediate layers (nth layers) using the following equation 2.

$${δ}_{j}^{n} = \{ {\sum }_{k = 1}^{{L}_{n + 1}} {δ}_{j}^{n + 1} {w}_{k , j}^{n + 1 , n} \} {out}_{j}^{n} ( 1 - {out}_{j}^{n} ) \qquad [ Equation 2 ]$$

In equation 2, w represents the bond-weighting values between the j^{th} neuron in the n^{th} layer and the k^{th} neuron in the n−1^{th} layer.

Next, the bond-weighting-learning unit 45 uses the error signals δⱼⁿ from the intermediate layers (nth layers) to calculate the amount of change Δw in the bond-weighting values w for each neuron using the following equation 3, and updates the bond-weighting values w for each neuron (step C6). In the following equation 3, η represents the learning rate, and it is set in the learning performed by the evaluator to η₁(0<η₁≦1).
Δwⱼᵢⁿⁿ⁻¹=−ηδⱼⁿoutⱼⁿ⁻¹ [Equation 3]

In step C6, learning is performed for the pre-learned data for the set number of samples T₁, then the squared error E shown in the following equation 4 is checked to determine whether or not it is less than the preset reference value E₁ for pre-learning (step C7), and the operation of step C6 is repeated until the squared error E is less than the reference value E₁. A number of learning repetitions S for which it is estimated that the squared error E will be less than the reference value E₁ may be set beforehand, and by doing so it is possible to repeat the operation of step C6 for that number of learning repetitions S.

$$E = \frac{1}{2} {\sum }_{j}^{{L}_{N}} ( {y}_{j} - {out}_{j}^{N} ) \qquad [ Equation 4 ]$$

In step C7, when it is determined that the squared error E is less than the reference value E₁, the bond-weighting-learning unit 45 outputs the bond-weighting values w for each of the pre-learned neurons by way of the bond-weighting-output unit 47 (step C8), and the bond-weighting values w for each of the neurons output from the bond-weighting-output unit 47 are stored in the impression-data-conversion unit 14.

Next, FIG. 6, FIG. 9 and FIG. 10 will be used to explain in detail the learning operation for learning the song map used in the mapping operation (step A6) by the song-mapping unit 16.

A memory medium such as a CD, DVD or the like on which song data is stored is set into the song-data-input unit 41, and song data is input from the song-data-input unit 41 (step D1), then the audio-output unit 42 outputs the song data input from the song-data-input unit 41 as audio output (step D2), and by listening to the audio output from the audio-output unit 42, the evaluator evaluates the impression of the song according to emotion, and inputs the evaluation results as impression data from the impression-data-input unit 44 (step D3), and the song-map-learning unit 46 receives the impression data input from the impression-data-input unit 44 as input vectors for the self-organized map. In this embodiment, the eight items ‘bright, dark’, ‘heavy, light’, ‘hard, soft’, ‘stable, unstable’, ‘clear, unclear’, ‘smooth, crisp’, ‘intense, mild’, and ‘thick, thin’ that are determined according to human emotion are set as the evaluation items for the impression, and seven levels of evaluation for each evaluation item are received by the song-data-input unit 41 as impression data.

The song-map-learning unit 46 uses the impression data input from the impression-data-input unit 44 as input vectors xⱼ(t) εRⁿ, and learns the characteristic vectors mᵢ(t) εRⁿ for each of the neurons. Here, t indicates the number of times learning has been performed, and the setting value T for setting the number of times to perform learning is set in advance, and learning is performed the number of times t=0, 1, . . . , T. Here, R expresses the evaluation levels of the evaluation items, and n indicates the number of items of impression data.

Initial values are set for the characteristic vectors m_{c}(0) for each of the neurons. Of the evaluation items for the impression data, index-evaluation items that will become an index when displaying the song map are set in advance, and decreasing values going from 1 to 0 from one end of the song map to the other end of the song map are set as initial values for the data corresponding to the index-evaluation items for the characteristic vectors m_{c}(0) for each of the neurons, and initial values are set randomly in the range 0 to 1 for the data corresponding to evaluation items other than the index-evaluation items. The index-evaluation items can be set up to the same number of dimensions of the song map, for example, in the case of a 2-dimensional song map, it is possible to set up to two index-evaluation items. In FIG. 10, the evaluation item indicating the ‘bright, dark’ step and the evaluation item indicating the ‘heavy, light’ step are set in advance as the index-evaluation items, and indicates initial values for when a 2-dimensional SOM in which the neurons are arranged in a 100×100 square shape is used as song map, and decreasing values for the first items of data of the characteristic vectors m_{c}(0) going from 1 toward 0 going from the left to the right corresponding to the evaluation items indicating the ‘bright, dark’ step are set as initial values, and decreasing values for the second items of data of the characteristic vectors m_{c}(0) going from 1 toward 0 going from the top to the bottom corresponding to the evaluation items indicating the ‘heavy, light’ step are set as initial values, and random values r in the range 0 to 1 are set as initial values for data corresponding to evaluation items other than the index-evaluation items.

Next, the song-map-learning unit 46 finds the winner neuron c that is nearest to xⱼ(t), or in other words, finds the winner neuron c that minimizes ∥xⱼ(t)−m_{c}(t)∥, and updates the characteristic vector m_{c}(t) of the winner neuron c, and the respective characteristic vectors mᵢ(t)(iεNc) for the set Nc of proximity neurons i near the winner neuron c according to the following equation 5 (step D4). The proximity radius for determining the proximity neurons i is set in advance.
mᵢ(t+1)=mᵢ(t)+h_{ci}(t)└xⱼ(t)−mᵢ(t)┘ [Equation 5]

In equation 5, h_{ci}(t) expresses the learning rate and is found from the following equation 6.

$${h}_{ci} ( t ) = {α}_{init} ( 1 - \frac{t}{T} ) exp ( - \frac{‖ {m}_{c} - {m}_{i} ‖}{2 {R}^{2} ( t )} ) \qquad [ Equation 6 ]$$

Here, αᵢₙᵢₜ is the initial value for the learning rate, and R²(t) is a uniformly decreasing linear function or an exponential function.

Next, the song-map-learning unit 46 determines whether or not the number of times learning has been performed t has reached the setting value T (step D5), and it repeats the processing operation of step D1 to step D4 until the number of times learning has been performed t has reached the setting value T, and when the number of times learning has been performed t reaches the setting value T, the same processing operation is performed again from the first sample. When the number of repetitions reaches the preset number of times S, the characteristic-vector-output unit 48 outputs the learned characteristic vectors mᵢ(T) εRⁿ (step D6). The characteristic vectors mᵢ(T) that are output for each of the neuron i are stored as song map in the song-map-memory unit 17 of the song-search apparatus 10.

In this way, the learned song map is such that for the index-evaluation items the neurons of the song map have a specified trend going from one end to the other end. In other words, in the case where the evaluation item indicating the ‘bright, dark’ step and the evaluation item indicating the ‘heavy, light’ step are set as the index-evaluation items, and the learning is performed based on neurons having initial values shown in FIG. 10, the closer the neurons are to the left side the closer they are to the evaluation step ‘bright’; the closer the neurons are to the right side the closer they are to the evaluation step ‘dark’; the closer the neurons are to the top the closer they are to the evaluation step ‘heavy’; and the closer the neurons are to the bottom the closer they are to the evaluation step ‘light’.

Next, the method for displaying the mapping status of song map by the song-search apparatus 10 will be explained in detail.

The song-search unit 18 displays a search screen 50 as shown in FIG. 11 on the PC-display unit 20, and this search screen 50 comprises: a mapping-status-display-area 51 in which the mapping status of the song data stored in the song-map-memory unit 17 are displayed; a search-conditions-input area 52 in which the search conditions are input; a search-results-display area 53 in which the search results are displayed; and a re-learning-instruction area 70 for giving instructions to re-learn the hierarchical-type neural network.

The mapping-status-display area 51 is an area that displays the mapping status of the song map stored in the song-map-memory unit 17, and it comprises: a song-map-display area 511; display-contents-instruction buttons 512; and a display-contents-instruction button 513.

In the song-map-display area 511, points equaling the total number of neurons in the song map are correlated with and assigned to each neurons, and the status of the neurons in the song map is displayed by the points. In this embodiment, a 2-dimensional SOM in which the neurons are arranged in a 100×100 square shape is used, so the status of the each neurons are displayed by 100×100 points. Also, in this embodiment, the neurons in the song map for the index-evaluation items have a specified trend going from one end to the other end, or in other words, in the left-right direction has a ‘bright, dark’ trend and in the top-bottom direction has a ‘heavy, light’ trend, so as shown in FIG. 12, by referencing the points displayed in the song-map-display area 511, it is easy to see that the song data that is mapped on the neurons close to the left side is close to the ‘bright’ evaluation step; the song data that is mapped on the neurons close to the right side is close to the ‘dark’ evaluation step; the song data that is mapped on the neurons close to the top is close to the ‘heavy’ evaluation step; and the song data that is mapped on the neurons close to the bottom is close to the ‘light’ evaluation step.

The display-contents-instruction buttons 512 are buttons for giving instructions for the neurons displayed in the song-map-display area 511, and comprise a map-display button 512a, an entire-songs-display button 512b and a found-songs-display button 512c.

The map-display button 512a is a button that gives instructions to display all of the neurons of the song map in order to check characteristic vectors mᵢ(T) εRⁿ of all of the neurons of the song map, and when the map-display button 512a is clicked on using the PC-control unit 19, the song-search unit 18 reads the characteristic vectors mᵢ(T) εRⁿ of all of the neurons in the song map that is stored in the song-map-memory unit 17, and all of the neurons corresponding to the display contents instructed using the display-contents-instruction button 513 are displayed in the song-map-display area 511.

The entire-songs-display button 512b is a button that gives instructions to display the neurons for which song data is mapped in order to check the characteristic vectors mᵢ(T) εRⁿ of the neurons in which song data is mapped. And when the entire-songs-display button 5121b is clicked on using the PC-control unit 19, the song-search unit 18 reads the characteristic vectors mᵢ(T) εRⁿ of the neurons in which song data is mapped in song map stored in the song-map-memory unit 17, and displays the neurons for which song data is mapped and that correspond to the display contents instructed by the display-contents-instruction button 513 in the song-map-display area 511. Not only is it possible to display the neurons for which song data are mapped, but it is also possible to display all of the neurons in the song-map-display area 511, and to change the display format for neurons for which song data is mapped and other neurons (non-flashing display and flashing display, white circle and dark circle, etc.), making it possible to distinguish between the neurons for which song data is mapped and other neurons.

The found-songs-display button 512c is a button that gives instructions to display neurons for which found song data is mapped in order to check the characteristic vectors mᵢ(T) εRⁿ of the neurons for which song data found by searching, as will be described later, are mapped, and when the found-songs-display button 512c is clicked on using the PC-control unit 19, the song-search unit 18 reads the characteristic vectors mᵢ(T) εRⁿ of the neurons for which found song data are mapped on the song map stored in the song-map-memory unit 17, and displays the neurons for which found song data are mapped and that corresponds to the display contents designated by the display-contents-instruction button 513 in the song-map-display area 511. Not only is it possible to display the neurons for which found song data are mapped, but it is also possible to display all of the neurons in the song-map-display area 511, and to change the display format for neurons for which found song data is mapped and other neurons (non-flashing display and flashing display, white circle and dark circle, etc.), making it possible to distinguish between the neurons for which found song data is mapped and other neurons.

The display-contents-instruction button 513 have buttons corresponding to each of the evaluation items of the impression data, and according to the values of the characteristic vectors mᵢ(T) εRⁿ of the each neurons that correspond to the evaluation item of the impression data corresponding to the display-contents-instruction button 513 that is clicked on using the PC-control unit 19, the song-search unit 18 expresses the each neurons displayed in the song-map-display area 511 in a shade. For example, in the case where the display-contents-instruction button 513 for the evaluation item indicating the ‘hard, soft’ evaluation step is clicked on, as shown in FIG. 13, according to the values of the characteristic vectors mᵢ(T) εRⁿ of the each neurons that correspond to evaluation item indicating the ‘hard, soft’ evaluation step, the song-search unit 18 displays the each neurons displayed in the song-map-display area 511 such that the closer they are to ‘hard’ the darker they are displayed, and the closer they are to ‘soft’ the lighter they are displayed.

Also, different colors are assigned to each of the evaluation items of the impression data, and the song-search unit 18 displays the each neurons in the song-map-display area 511 in the color assigned to the evaluation item corresponding to the display-contents-instruction button 513 that is clicked on using the PC-control unit 19. For example, the color ‘Red’ is assigned to the evaluation item that indicates the ‘bright, dark’ evaluation step, and when the display-contents-instruction button 513 of the evaluation item that indicates the ‘bright, dark’ evaluation step is clicked on, together with displaying the each neurons in the song-map-display area 511 in the color ‘Red’, the song-search unit 18 displays the each neurons displayed in the song-map-display area 511 such that the closer they are to ‘bright’ the darker they are displayed, and the closer they are to ‘dark’ the lighter they are displayed, according to the values of the characteristic vectors mᵢ(T) εRⁿ of the each neurons corresponding to the evaluation item that indicates the ‘bright, dark’ evaluation step. By doing this, it is possible for the user to easily recognize the status of each of the neurons, or in other words, the status for each evaluation item of the characteristic vectors mᵢ(T) εRⁿ.

In the case where a plurality of the display-contents-instruction buttons 513 are clicked on, the each neurons are displayed in the song-map-display area 511 in a mixture of the colors assigned to the evaluation items respectively corresponding to the of display-contents-instruction button 513 that were clicked on using the PC-control unit 19. For example, in the case where the color ‘Red’ is assigned to the evaluation item indicating the ‘bright, dark’ evaluation step, and the color ‘Blue’ is assigned to the evaluation item indicating the ‘heavy, light’ evaluation step, and the display-contents-instruction button 513 for the evaluation item indicating the ‘bright, dark’ evaluation step and the evaluation item indicating the ‘heavy, light’ evaluation step are clicked on, together with displaying the each neurons in the song-map-display area 511 with mixing colors of ‘Red’ and ‘Blue’, the song-search unit 18 displays the each neurons displayed in the song-map-display area 511 such that the closer they are to ‘bright’ the darker the ‘Red’ color is displayed; and the closer they are to ‘dark’ the lighter the ‘Red’ color is displayed, according to the values of the characteristic vectors mᵢ(T) εRⁿ of the each neurons corresponding to the evaluation item that indicates the ‘bright, dark’ evaluation step; the song-search unit 18 displays the each neurons displayed in the song-map-display area 511 such that the closer they are to ‘heavy’ the darker the ‘Blue’ color is displayed, and the closer they are to ‘light’ the lighter the ‘Blue’ color is displayed according to the values of the characteristic vectors mᵢ(T) εRⁿ of the each neurons corresponding to the evaluation item that indicates the ‘heavy, Light’ evaluation step. In this case, neurons that are near ‘bright’ and ‘heavy’ are displayed in a color that is close to dark ‘Purple’; neurons that are near ‘bright’ and ‘Light’ are displayed in a color that is close to dark ‘Red’; neurons that are near ‘dark’ and ‘heavy’ are displayed in a color close to dark ‘Blue’; and neurons that are near ‘dark’ and ‘light’ are displayed in a color close to light ‘Purple’, so it is possible for the user to easily recognize the status of the each neurons, or in other words, the status for each evaluation item of the characteristic vectors mᵢ(T) εRⁿ. When none of the display-contents-instruction buttons 513 has been clicked on, the each neurons are displayed with the same density.

Also, this embodiment is constructed such that, according to the values of the characteristic vectors mᵢ(T) εRⁿ of the each neurons, the each neurons displayed in the song-map-display area 511 are displayed in a dark shade, however, the construction is also possible in which each neurons displayed in the song-map-display area 511 are displayed in a dark shade, according to the values of the impression data of the song data mapped on the each neurons. In the case where a plurality of song data is mapped for the same neuron, it is possible to express the each neurons displayed in the song-map-display area 511 in a dark shade, according to one of the impression data or according to the average of the impression data.

Next, FIG. 7 will be used to explain in detail the song search operation by the song-search apparatus 10.

The song-search unit 18 displays a search-conditions-input area 52 for inputting search conditions on the PC-display unit 20, and receives user input from the PC-control unit 19.

As shown in FIG. 14, the search-conditions-input area 52 comprises: an impression-data-input area 521 in which impression data is input as search conditions; a bibliographic-data-input area 522 in which bibliographic data is input as search conditions; and a search-execution button 523 that gives an instruction to execute a search. When the user inputs impression data or bibliographic data as search conditions from the PC-control unit 19 (step E1), and then clicks on the search-execution button 523, an instruction is given to the song-search unit 18 to perform a search based on the impression data and bibliographic data. As shown in FIG. 14, input of impression data from the PC-control unit 19 is performed by inputting the each evaluation items of impression data using 7-steps evaluation.

The song-search unit 18 searches the song database 15 based on the impression data and bibliographic data input from the PC-control unit 19 (step E2), and displays search results in the search-results-display area 53 as shown in FIG. 15.

Searching based on the impression data input from the PC-control unit 19 uses the impression data input from the PC-control unit 19 as input vectors xⱼ, and uses the impression data stored with the song data in the song database 15 as target search vectors Xⱼ, and performs the search in order of target search vectors Xⱼ that are the closest to the input vectors xⱼ, or in other words, in order of smallest Euclidean distance ∥Xⱼ−xⱼ∥. The number of items searched can be preset or can be set arbitrarily by the user. Also, in the case where both impression data and bibliographic data are used as search conditions, searching based on the impression data is performed after performing a search based on bibliographic data.

Also, other than performing a search using the search-conditions-input area 52, searching can be performed by using the song-map-display area 511 in the mapping-status-display area 51. By specifying evaluation items for the impression data using the display-contents-instruction button 513, it is possible to know the status of the neurons for the specified evaluation items by the color and shading, and by specifying the song-selection area 514 on the song-map-display area 511 using the PC-control unit 19, the song-search unit 18 searches for the song data mapped inside the song-selection area 514 and displays in search-results-display area 53 as found results.

Next, the user selects a representative song from among the search results displayed in the search-results-display area 53 (step E3), and by clicking on the representative-song-search-execution button 531, an instruction is given to the song-search unit 18 to perform a search based on the representative songs. At this time, when the output button 532 is clicked on, the song-search unit 18 outputs the song data of the search results displayed in the search-results-display area 53 to the terminal apparatus 30 by way of the sending/receiving unit 21.

The song-search unit 18 searches the song map stored in the song-map-memory unit 17 based on the selected representative songs (step E4), and displays the neurons mapped with the representative song and the song data mapped on the proximity neurons in the search-results-display area 53 as representative song search results. The proximity radius for setting the proximity neurons can be set in advance or can be set arbitrarily by the user.

Next, as shown in FIG. 16, the user selects song data from among the representative song search results displayed in the search-results-display area 53 to output to the terminal apparatus 30 (step E5), and by clicking on the output button 532, an instruction is given to the song-search unit 18 to output the selected song data, and then the song-search unit 18 outputs the song data selected by the user to the terminal apparatus 30 by way of the sending/receiving unit 21 (step E6).

Besides performing a representative song search using the search-conditions-input area 52 and the mapping-status-display area 51, it is possible to display the entire-songs-list-display area 54 as shown in FIG. 17 in which a list of all of the stored song is displayed on the search screen 50, and to directly select a representative song from the entire song list, and then by clicking on the representative-song-selection-execution button 541, give an instruction to the song-search unit 18 to perform a search based on the selected representative song.

Furthermore, other than performing a search as described above, it is also possible to set neurons (or songs) that correspond to keywords expressed in words such as ‘bright songs’, ‘fun songs’ or ‘soothing songs’, and then search for songs by selecting the keyword. In other words, by displaying a keyword-search area 55 as shown in FIG. 18A on the search screen 50 and then selecting some keywords from a list of keywords displayed in a keyword-selection area 551 and by clicking on an auto-search button 553, an instruction is given to the song-search unit 18 to perform a search based on the neurons corresponding to the selected keywords. When a song corresponding to the selected keywords is set in a set-song-display area 552 as shown in FIG. 18A, the song is displayed as a set song, and in this case, by clicking on the auto-search button 553, an instruction is given to the song-search unit 18 to perform a search using the set song corresponding to the selected keywords as a representative song. The set-song-change button 554 shown in FIG. 18A is used to change the song corresponding to the keywords, so by clicking on the set-song-change button 554, the entire song list is displayed, and by selecting a song from among the entire song list, it is possible to change the song corresponding to the keywords. The neurons (or songs) corresponding to the keywords can be set by assigning impression data to a keyword, and using the impression data as input vectors Xⱼ and correlating it with the neurons (or songs) that are the closest to the input vectors xⱼ, or can be set arbitrarily by the user.

When neurons corresponding with keywords are set in this way, then as shown in FIG. 18B, by clicking on a neuron in the song-map-display area 511 for which song data are mapped, the keywords corresponding to the neuron clicked on are displayed in a pop-up display as the keyword display 515, making it possible to easily search for songs using the song-map-display area 511.

Next, FIG. 19 and FIG. 20 will be used to explain in detail correction operation of impression data performed by the song-search apparatus.

As shown in FIG. 15 and FIG. 16, in the search-results-display area 53 there are trial-listening buttons 533 for each found song, and by clicking on a trial-listening button 533 using the PC-control unit 19 (step F1), the song-search unit 18 reads song data and impression data for the corresponding song from the song database 15, and together with outputting the read song data to the audio-output unit 22, it displays a correction-instruction area 60 on the PC-display unit 20 as shown in FIG. 20, and displays the read impression data in the correction-data-input area 61 (step F2). As shown in FIG. 20, for the impression data displayed in the correction-data-input area 61, the level for each evaluation item is expressed by the position of a point.

The audio-output unit 22 outputs the song data input from the song-search unit 18 as audio output (step F3), and it is possible for the user to listen to the songs found based on the impression data or bibliographic data and to select a representative song, and then it is possible to listen to songs found based on the representative song and check the song to output to the terminal apparatus 30. Also, during trial listening, by clicking on the audio-output-stop button 64 in the correction-instruction area 60 using the PC-control unit 19, the song-search unit 18 stops the output of song data to the audio-output unit 22 and stops the audio output, as well as removes the display of the correction-instruction area 60.

When the user feels uncomfortable with the audio output from the audio-output unit 22, or in other words, when the user feels that the impression data displayed in the correction-data-input area 61 is not correct, or feels that the search results are not suitable, it is possible to correct the impression data using either one of the following two methods.

The first method for correcting the impression data is to input corrections for correcting the impression data displayed in the correction-data-input area 61 using the PC-control unit 19, or in other words, to move the position of the points for each of the evaluation items (step F4), and then click on the correction-execution button 62 (step F5).

By clicking on the correction-execution button 62, the corrected impression data (hereafter the corrected impression data will be called the corrected data) is input to the song-search unit 18, and together with updating impression data stored in the song database 15 with the input corrected data, the song-search unit 18 reads characteristic data from the song database 15 and stores the corrected data and characteristic data as re-learned data in the corrected-data-memory unit 23 (step F6).

The second method for correcting the impression data is to click on the auto-correction button 63 using the PC-control unit 19. After clicking on the auto-correction button 63 (step F7), a correction instruction is input to the song-search unit 18, and the song-search unit 18 automatically corrects the impression data of song for which the correction instruction was given in a direction going away from the search conditions (step F8), then updates the impression data stored in the song database 15 with the automatically corrected data, as well as reads characteristic data from the song database 15 and stores the corrected data and characteristic data as re-learned data in the corrected-data-memory unit 23 (step F6).

Auto correction by the song-search unit 18 is executed when the search is performed based on impression data input into the impression-data-input area 521 or based on impression data of a representative song, and it specifies the most characteristic evaluation item of the impression data of the search conditions, and moves the level of that evaluation item in a specified amount in a leaving direction. For example, in the case where the impression data of the search conditions is shown in the impression-data-input area 521 of FIG. 14, the evaluation item indicating the ‘bright, dark’ step is set at the brightest evaluation, so the evaluation item indicating the ‘bright, dark’ step is specified as the most characteristic evaluation item, and the ‘bright, dark’ step is moved in the dark direction. When the search is based on bibliographic data, it is not possible to select the second method, and in this case, control can be performed such that the auto-correction button 63 cannot be clicked on, or the auto-correction button 63 can be removed from the correction-instruction area 60.

After the newly corrected data has been stored in the song-map-memory unit 17, the song-mapping unit 16 remaps the songs using the corrected data (step F9), and stores the song map that was remapped based on the corrected data in the song-map-memory unit 17.

Also, besides the first and second methods described above, the impression data for the song data could be corrected by specifying a point in the song-map-display area 511 of the mapping-status-display area 51 to specify song data mapped on the neurons corresponding to that point, and then moving the specified song data in the song-map-display area 511. In this case, by specifying an evaluation item of the impression data using the display-contents-instruction buttons 513, it is possible to know the status of the neurons of the specified evaluation item by color and shading, and the song data for which the impression data is to be correction is dragged and moved to a desired point, then the characteristic vectors mᵢ(T) εRⁿ of the neurons corresponding to the point to where the song data was moved to is taken to be the correction data.

Next, the correction operation for correcting impression data by using the terminal apparatus 30 will be explained in detail.

When the user feels uncomfortable when listening to a song using the terminal apparatus 30, or in other words, when the search results are felt to be unsuitable, the user uses the terminal-control unit 33 to input a correction instruction to correct the impression data corresponding to the song being played. The correction instruction input is performed, for example, by having a special button on the terminal-control unit 33 for the correction instruction input, and by pressing that button while playing the song. Instead of the special button, it is also possible to assign the function of the correction instruction input to any of the buttons while a song is being played.

The correction instruction that is input from the terminal-control unit 33 is stored in the search-results-memory unit 32, and when the terminal apparatus 30 is connected to the song-search apparatus 10, the correction instruction is sent to the song-search apparatus 10 by the sending/receiving unit 31. The sending/receiving unit 21 of the song-search apparatus 10 receives the correction instruction from the terminal-control unit 33 and outputs the received correction instruction to the song-search unit 18.

The song-search unit 18 to which the correction instruction was input automatically corrects the impression data of the song for which correction was instructed in a direction going away from the search conditions, and updates the impression data stored in the song database 15 with the automatically corrected data, as well as reads characteristic data from the song database 15 and stores the corrected data and characteristic data in the corrected-data-memory unit 23 as re-learned data.

Next, FIG. 21 will be used to explain in detail the re-learning operation for re-learning the hierarchical-type neural network used by the impression-data-conversion unit 14.

The neural-network-learning unit 24 counts the number of re-learned data newly stored in the corrected-data-memory unit 23 (step G1), and determines whether or not the number of re-learned data newly stored in the corrected-data-memory unit 23 has reached a specified number (step G2), and when the number of re-learned data newly stored in the corrected-data-memory unit 23 has reached the specified number, it reads the bond-weighting values w for each of the neurons from the impression-data-conversion unit 14 (step G3), and using the read bond-weighting values w for each of the neurons as initial values, re-learns the hierarchical-type neural network using the re-learned data stored in the corrected-data-memory unit 23, or in other words, re-learns the bond-weighting values w for each of the neurons (step G4).

The number of re-learned data, or in other words, specified number of re-learned data for which re-learning of the hierarchical-type neural network starts can be set in advance, or can be set by the user. Also, it is possible to measure the amount of time that has elapsed from when the previous re-learning of the hierarchical-type neural network was performed, and start re-learning of the hierarchical-type neural network when the amount of time that has elapsed reaches a specified amount of time, or the amount of time, or in other words, specified amount of time that elapses that starts re-learning of the hierarchical-type neural network can be set in advance, or can be set by the user.

Re-learning of the hierarchical-type neural network by the neural-network-learning unit 24 is performed by the same learning method as that performed by the neural-network-learning apparatus 40, and the neural-network-learning unit 24 updates the bond-weighting values w of each of the neurons that re-learned the bond-weighting values w for each of the neurons of the impression-data-conversion unit 14 (step G5). The re-learned data used for re-learning can be deleted from the corrected-data-memory unit 23, however, by storing it in the corrected-data-memory unit 23, and using it the next time re-learning is performed, the amount of re-learning data used during re-learning of the hierarchical-type neural network increases, so accuracy of the re-learning is improved. However, when the re-learned data used for re-learning is stored in the corrected-data-memory unit 23, it is necessary to delete the previous corrected data, when new corrected data for the same song is stored, so that there are not two sets of corrected data for the same song.

The re-learning operation of the hierarchical-type neural network by the neural-network-learning unit 24 can be performed using timesharing so that it does not interfere with other processes such as the song-registration operation or song-search operation. In other words, when other processing is started while performing re-learning of the hierarchical-type neural network by the neural-network-learning unit 24, the re-learning operation is interrupted, and after the other processing ends, the re-learning operation is restarted. Also, the re-learning operation of the hierarchical-type neural network by the neural-network-learning unit 24 can be performed using timesharing during idling when starting up the song-search apparatus 10 or during the ending process during shut down.

Re-learning of the hierarchical-type neural network can be performed by an instruction from the user. As shown in FIG. 22, the relearning-instruction area 70 on the search screen 50 comprises: a correction-information-display area 71; a relearning-execution button 72; and re-registration-execution button 73. And the number of items of corrected data stored in the corrected-data-memory unit 23, the amount of time elapsed since the previous re-learning of the hierarchical-type neural network was performed, and the amount of time elapsed since the previous re-registration of song data was performed are displayed in the correction-information-display area 71. The number of items of correction data displayed in the correction-information-display area 71 is displayed with the number of items of newly stored corrected data (corrected data not used for re-learning) and the number of corrected data used for re-learning, where the number of corrected data used for re-learning is displayed in parentheses.

The user checks the information displayed in the correction-information-display area 71, and when it is determined that it is necessary to perform re-learning of the hierarchical-type neural network, the user clicks on the relearning-execution button 72 using the PC-control unit 19. After clicking on the relearning-execution button 72, a re-learning instruction is output to the neural-network-learning unit 24, and the neural-network-learning unit 24 reads the bond-weighting values w for each of neurons from the impression-data-conversion unit 14, and then using the read bond-weighting values w for each of neurons as initial values, performs re-learning of the hierarchical-type neural network using the re-learned data stored in the corrected-data-memory unit 23, or in other words, re-learns the bond-weighting values w for each of neurons, and updates the bond-weighting values w for each of neurons in the impression-data-conversion unit 14 with the re-learned bond-weighting values w for each of neurons.

Next, FIG. 23 will be used to explain in detail the re-registration operation of song data by the song-search apparatus 10.

By clicking on the re-registration-execution button 73 in the correction-information-display area 71 using the PC-control unit 19, re-registration operation of all of the song data stored in the song database 15 begins.

After the re-registration-execution button 73 is clicked on using the PC-control unit 19 (step H1), a re-registration instruction is output to the neural-network-learning unit 24, and the neural-network-learning unit 24 reads the bond-weighting values w for each neuron from the impression-data-conversion unit 14 (step H2), then using the read bond-weighting values w initial values, it performs re-learning of the hierarchical-type neural network using the re-learned data stored in the corrected-data-memory unit 23, or in other words, re-learns the bond-weighting values w for each neuron (step H3), and updates the bond-weighting values w for each neuron in the impression-data-conversion unit 14 to the re-learned bond-weighting values w for each neuron (step H4).

Next, the neural-network-learning unit 24 instructs the song-mapping unit 16 to delete all of the song mapped on the song map, and the song-mapping unit 16 deletes all of the songs mapped on the song map stored in the song-map-memory unit 17 (step H5).

Next, the neural-network-learning unit 24 instructs the impression-data-conversion unit 14 to update the impression data stored in the song database 15, and the impression-data-conversion unit 14 reads the characteristic data of the song data stored in the song database 15 (step H6), and then uses the re-learned hierarchical-type neural network to convert the read characteristic data to impression data (step H7), and together with updating the impression data of the song data stored in the song database 15 (step H8), outputs the converted impression data to the song-mapping unit 16. The song-mapping unit 16 remaps the song based on the updated impression data input from the impression-data-conversion unit 14 (step H9).

The neural-network-learning unit 24 determines whether or not there are song data for which the impression data has not been updated (step H10), and when there are song data for which the impression data has not been updated, it repeats the process from step H6 to step H9, and when there is no song data for which the impression data has not been updated, or in other words, when the impression data for all of the song data stored in the song database 15 has been updated, it ends the re-registration operation of song data.

As explained above, this embodiment is a self-organized map that comprises a plurality of neurons that involved characteristic vectors made up of data corresponding to the respective characteristic data of the song data, and by mapping song data on a song map for which preset index-evaluation items have a trend from one end to the other end, and by displaying the status of the song map by points that correspond to respective neurons, it is possible to easily know the trend of the song data stored in the song database 15 by simply looking at the display of the song map on which song data are mapped.

The present invention is not limited to the embodiments described above, and it is clear that the embodiments can be suitably changed within the technical scope of the present invention. Also, the number, location, shape, etc. of the component parts above are not limited by the embodiments described above, and any suitable number, location, shape, etc. is possible in applying the present invention. In the drawing, the same reference numbers are used for identical components elements

The song search system and song search method of the present invention is a self-organized map that comprises a plurality of neurons that include characteristic vectors made up of data corresponding to a plurality of evaluation items that indicate the characteristics of the song data, and by mapping song data on a song map for which preset index-evaluation items have a trend from one end to the other end, and by displaying the status of the song map by points that correspond to respective neurons, it is possible to easily know the trend of the song data stored in the song database by simply looking at the display of the song map on which song data are mapped.

1. A song search system that searches for desired song data from among a plurality of song data stored in a song database, the song search system comprising:
a song-map-memory means that stores song map which a self-organized map that comprises a plurality of neurons that include characteristic vectors made up of data corresponding to a plurality of evaluation items that indicate the characteristics of said song data; and where the neurons have a trend from one end to the other end for index-evaluations items that are preset from among said evaluation items;
a song-mapping means that maps said song data onto some of the neurons of said song map based on a plurality of items of data that display the characteristics of said song data; and
a displaying means that displays status of said song map using points that correspond to respective neurons in said song map.

2. The song search system as claimed in claim 1,
wherein said song map performs learning using values decreasing from one end to the other end as initial values for said index-evaluation items.

3. The song search system as claimed in claims 1 or 2,
wherein said song map is a 2-dimensional map; and two evaluation items from among said evaluation items are set as said index-evaluation items.

4. A song search method that searches for desired song data from among a plurality of song data stored in a song database, the song search method comprising:
storing song map which is a self-organized map that comprises a plurality of neurons that include characteristic vectors made up of data corresponding to a plurality of evaluation items that indicate the characteristics of said song data; and where the neurons have a trend from one end to the other end for index-evaluations items that are preset from among said evaluation items;
mapping said song data onto some of the neurons of said song map based on a plurality of items of data that display the characteristics of said song data; and
displaying status of said song map using points that correspond to respective neurons in said song map.

5. The song search method as claimed in claim 4,
wherein said song map performs learning using values decreasing from one end to the other end as initial values for said index-evaluation items.

6. The song search method as claimed in claims 4 or 5,
wherein said song map is a 2-dimensional map; and two evaluation items from among said evaluation items are set as said index-evaluation items.

7. A song search program for making a computer execute the song search method as claimed in 6 claim 4.
